(19) United States
(12) Patent Application Publication
(10) Pub. No.: US 2005/0075937 A1
(43) Pub. Date: Apr. 7, 2005

(54) Rack equipment management information coordination system and method

(76) Inventors: Kirk Michael Bresniker, Roseville, CA (US); Ricardo Espinoza-Ibarra, Lincoln, CA (US); Andrew Harvey Barr, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/678,464

(22) Filed: Oct. 3, 2003

(51) Int. Cl. G06F 17/60

(52) U.S. Cl. 705/22; 705/28

(57) ABSTRACT

A rack equipment management information coordination and tracking system and method is disclosed. In one embodiment, a rack equipment management information coordination method is implemented. As part of the rack equipment management information coordination method a rack equipment management plan is formulated. Equipment description information detection is also automatically directed. Both the detected rack equipment description information and formulated rack equipment management plan are stored.

### FIELD OF THE INVENTION

The present invention relates to rack equipment management.

### BACKGROUND OF THE INVENTION

Electronic systems and circuits have made a significant contribution towards the advancement of modern society and are utilized in a number of applications to achieve advantageous results. Numerous electronic technologies such as digital computers, calculators, audio devices, video equipment, and telephone systems have facilitated increased productivity and reduced costs in analyzing and communicating data, ideas and trends in most areas of business, science, education and entertainment. Frequently, electronic systems designed to provide these advantageous results are realized through the leveraged utilization of centralized resources by distributed network nodes. While leveraged utilization of centralized resources is usually advantageous, coordinating and tracking information for managing operations of the centralized equipment is usually very complex and often involves significant amounts of information.

Centralizing certain resources within a distributed network typically provides desirable benefits. For example, centrally storing and/or processing information typically relieves the necessity of wasteful duplicative storage and/or processing resources at each remote networked node. However, managing large storage and processing capabilities of centralized resources is very complex and expensive. Clients interested in engaging a host to provide centralized resources and services typically have a desire to avoid providing the infrastructure, operation and maintenance directly themselves.

Centralized computing resource centers (e.g., server farms, Application Service Provider Centers, Internet Data Centers, Utility Data Centers, etc.) usually include a variety of equipment related to information processing mounted in racks. For example, a rack can include servers, routers, disk arrays, and operational support components (e.g., power distribution components, fans, etc.). The racks usually provide a convenient and efficient way to arrange computing equipment in a centralized operation location. The configuration of the rack structures usually follow conventional standards. However, the equipment mounted within a rack can vary dramatically. Collecting and maintaining the vast amount of diverse information typically associated with large and complicated centralized resources is usually very resource intensive. Further complicating the utilization of leveraged resources is the significant amount of administrative information that is usually associated with each of the numerous potential clients involved in the endeavor. In addition, attempts are sometimes made to track a variety of infrastructure support activity information that tends to add even greater complexity to management tasks.

Traditional attempts at collecting and tracking operational information and administrative client information in conventional centralized resource centers usually involve significant manual resource commitments. For example, some traditional attempts involve manually correlating numerous different types of information, including absolute maximum ratings defined by regulatory requirements of power supply vendors, amount of current flowing through a branch circuit, manual partial configuration of rack equipment, impacts of partial configuration on performance, local environmental conditions, cost of maintaining power and thermal envelopes, and economic value of computing services running on the rack equipment. Collecting, correlating, and tracking this information manually is labor intensive and typically requires a significant level of specialized knowledge and expertise.

The sheer number of possible characteristics of the different pieces of rack equipment and rack support equipment potentially deployed in a centralized resource center presents daunting manual tracking and organizing issues. This is further complicated by the variety of possible performance settings that each piece of rack equipment and support equipment may be capable of. It is also usually important to have information on various potential capacity limits and usage constraints. For example, equipment racks usually have predetermined fixed aggregate power consumption and thermal dissipation limits even though there are various different pieces of equipment mounted in a rack. The power consumption and thermal dissipation limitations are often referred to as the power and thermal “budget”. In addition, tracking information on numerous different client agreement terms is important. The equipment operation and performance levels should support client agreement terms in order to fulfill requirements of the agreement terms. However, traditional approaches are usually not flexible and often include inefficiencies. For example, equipment is usually set at a predetermined level which the agreement terms can not exceed (e.g., can not agree to provide services the equipment is not capable of). In addition, the agreements terms are usually constrained well below the potential equipment performance resulting in less than maximized efficient use of the equipment.

Manually collecting and correlating rack equipment information associated with operational management (e.g., capacity planning) usually requires the operator to have specialized expertise and extensive understanding of the unique features of each piece of equipment. Recognizing and interpreting the vast amount of different information that is relevant to centralized resource operation raises many challenging operational issues. Furthermore, misinterpreting and/or not recognizing the differences in the information can also be problematic. For example, not recognizing and/or misinterpreting the power consumption and/or heat dissipation characteristics of a piece of equipment can have detrimental impacts. If a piece of rack equipment is permitted to dissipate too much heat it could raise the temperature and result in operational errors and/or failures. In addition, attempts to interpret a variety of unconsolidated and/or uncorrelated information can result in false analysis of the system operations and/or condition. For example, without coordinated information, a piece of equipment raising the temperature of other nearby components to unacceptable levels could result in cascading failures.

### SUMMARY OF THE INVENTION

A rack equipment management information coordination and tracking system and method is disclosed. In one embodiment, a rack equipment management information coordination method is implemented. As part of the rack equipment management information coordination method a rack equipment management plan is formulated. Equipment description information detection is also automatically directed. Both the detected rack equipment description information and formulated rack equipment management plan are stored.

### BRIEF DESCRIPTION OF THE DRAWINGS

The accompanying drawings, which are incorporated in and form a part of this specification, illustrate embodiments of the invention by way of example and not by way of limitation. The drawings referred to in this specification should be understood as not being drawn to scale except if specifically noted.

FIG. 1 is a flow chart of a rack equipment management information coordination method in accordance with one embodiment of the present invention.

FIG. 2A is a block diagram of an exemplary equipment description information table stored in accordance with one implementation of the present invention.

FIG. 2B is a block diagram of an exemplary rack equipment management plan table stored in accordance with one implementation of the present invention.

FIG. 3 is a block diagram of a rack equipment management information coordination system in accordance with one embodiment of the present invention.

FIG. 4 is a block diagram of computer system, one embodiment of a computer system on which the present invention can be implemented.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it is understood the present invention may be practiced without these specific details. In other instances, some readily understood methods, procedures, components, and circuits have not been described in detail as not to unnecessarily obscure aspects of the current invention.

The present invention facilitates convenient and efficient collection and tracking of rack equipment information. A present invention rack equipment management information coordination system and method enables automatic detection, electronic encoding, manipulation and storage of rack equipment operating characteristics and activities. In one embodiment, a present invention rack equipment management information coordination system and method facilitates automatic establishment and tracking of equipment description information and rack equipment management plan information. For example, information on performance levels and management objectives for rack equipment, including optimized power consumption and thermal loading, can be obtained and stored in an organized and coordinated manner.

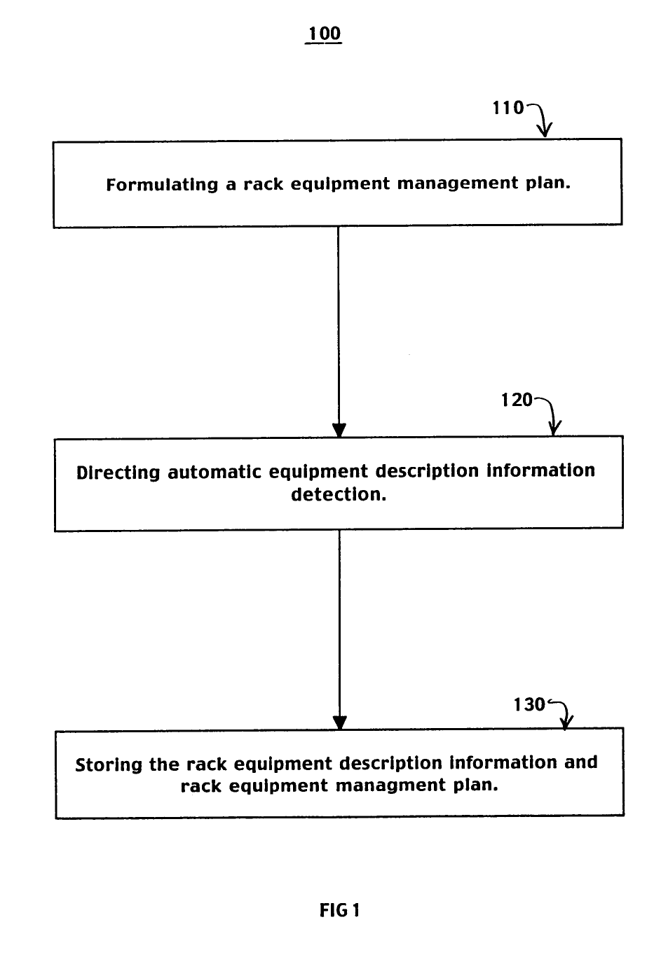

FIG. 1 is a flow chart of a rack equipment management information coordination method 100 in accordance with one embodiment of the present invention. Rack equipment management information coordination method 100 facilitates efficient collection and tracking of rack equipment description information and rack equipment management plan information. For example, rack equipment management information coordination method 100 includes automatic gathering, correlation and organization of rack equipment description information and rack equipment management plan information. Rack equipment management information coordination method 100 also facilitates efficient management of rack equipment and related support equipment operations (e.g., by collecting and organizing performance level information and providing a correspondence to operational management objectives).

In step 110, a rack equipment management plan is formulated. The rack equipment management plan can include rack equipment management and usage policies (e.g., guidelines). The rack equipment policies can be formulated to achieve a number of different rack equipment management objectives. The rack equipment management plan can establish associations between a rack equipment performance action and a particular trigger event. For example, the policy can indicate a particular performance level for a particular piece or type of rack equipment if a particular trigger event occurs. The performance levels can include power consumption and heat dissipation budget limitations. For example, if a particular performance level causes the piece of equipment to consume more power and/or dissipate more heat than is permitted by a rack power and thermal budget, a policy can indicate that rack equipment is not allowed to operate at that level.

Automatic equipment description information detection is directed in step 120. The equipment description information includes information on the characteristics, features, operations, status, unique identification, indication of equipment type, information on how to control the equipment, etc. The equipment description information can include information related to rack equipment (e.g., equipment mounted in a rack) and/or support equipment. The rack equipment description information can also include information indicating possible operation settings of rack equipment and information on how various operating levels can be achieved (e.g., commands to issue to the equipment to direct implementation of an operational setting and/or performance level).

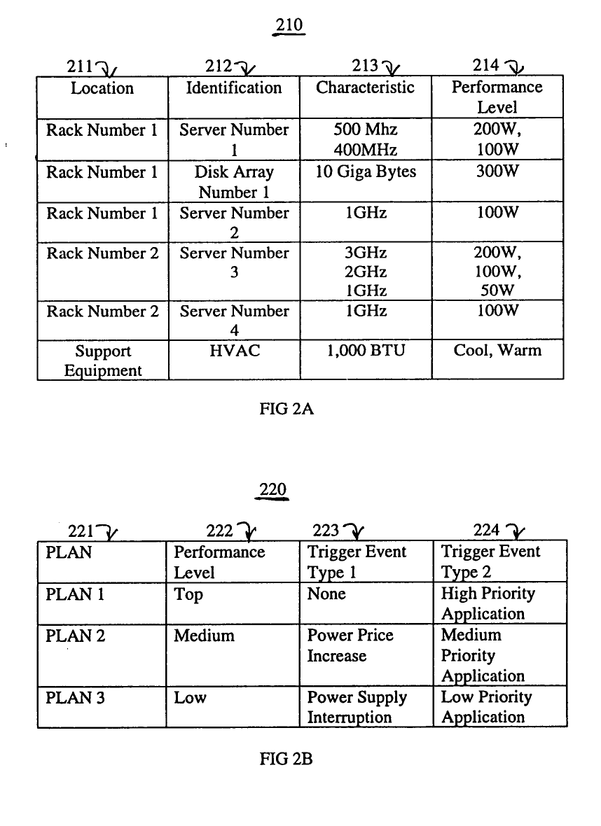

At step 130, the rack equipment description information and rack equipment management plan is stored. In one embodiment of the present invention, the rack equipment description information and the rack equipment management plan are stored on a computer readable medium. FIG. 2A is a block diagram of an exemplary equipment description information table 210 stored in accordance with one implementation of step 130. Column 211 includes an equipment type indication (e.g., rack equipment, support equipment, etc.) and also a rack location indication if applicable (e.g., the equipment is mounted in a particular rack). Column 212 includes identification of a particular piece of equipment. Characteristics of the equipment (e.g., processing speed, memory size, heating or cooling capacity, etc.) are included in column 213 and column 214 includes a performance level indication. It is appreciated that the present invention can include a variety of different possible performance level indications (e.g., power consumption, operating frequency of rack equipment, voltage of power supplied to rack equipment, processing speed of rack equipment, components enabled, etc.). FIG. 2B is a block diagram of an exemplary rack equipment management plan table 220. Rack equipment management plan table 220 includes plan indication column 221, performance level indication column 222, a first type trigger event column 223, and a second type trigger event column 224.

In one embodiment of the present invention, dynamic alterations or changes to an equipment management plan are supported. A client can forward a request to change terms and/or conditions in a usage policy agreement. For example, if a client is engaged in a very important project involving dedicated applications (e.g., a marketing program for a specific time) the client can request a higher level of service for the project (e.g., give the client access to higher performance equipment with access to auxiliary support functions for a requested time period).

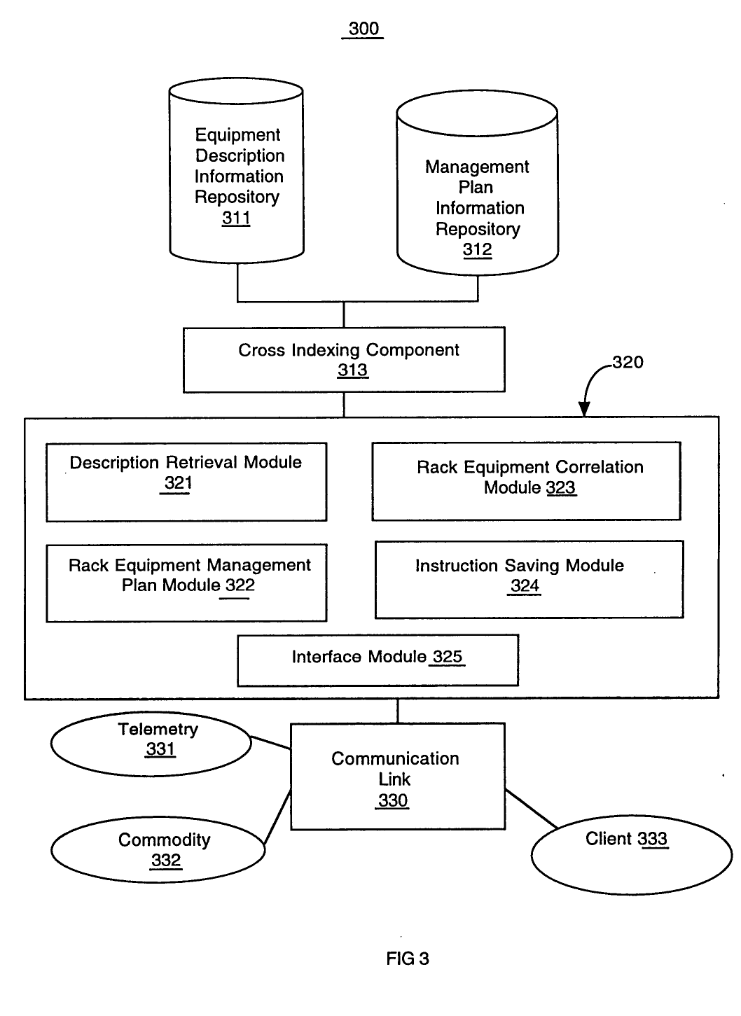

FIG. 3 is a block diagram of a rack equipment management information coordination system 300 in accordance with one embodiment of the present invention. Rack equipment management information coordination system 300 includes equipment description information repository 311, management plan information repository 312, cross indexing component 313, repository management component 320 and communication link 330. Equipment description information repository 311 tracks equipment description information. Management plan information repository 312 tracks rack equipment management plan information. Coordination component 313 coordinates correlations between the equipment description information and the rack equipment management plan information. Repository management component 320 manages information flow to and from equipment description information repository 311 and management plan information repository 312. Communication link 330 communicates information to and from repository management component 320. The information tracking features of management control component 300 are readily adaptable for a variety of information storage configurations.

Equipment description information repository 311 stores information associated with features and characteristics of rack equipment and support equipment. In one exemplary implementation, equipment description information repository 311 stores information indicating possible operation settings of rack equipment. For example, equipment description information repository 311 can store information indicating rack equipment is capable of operating at varying power levels (e.g., 200 W, 100 W or 50 W) and the corresponding heat generated at each level. The equipment information can also include performance level information. For example, a rack equipment unit can operate at 200 W in a full configuration, 100 W in a partial configuration (e.g., half the processors disabled, or half the memory disabled,) or 50 W running at half the normal speed. Equipment description information repository 311 can also store system specific information on how the various operating levels can be achieved (e.g., commands to issue to the equipment to direct implementation of an operational setting and/or performance level).

Management plan information repository 312 tracks management policy and guideline information associated with a rack equipment management plan. The policy information can provide a correlation between a trigger event and a rack equipment management objective or action. The management objective or action can include directing a performance level change and/or spawning another management event. The management objective or action can also include modifying operating characteristics of the equipment (e.g., changing operating frequency and/or voltage of rack equipment, turning on or off equipment, deactivating components, etc.) in response to environmental conditions, power availability, power price, rack loading, application implementation, and/or demand for capacity.

Coordination component 313 provides a correlation of information included in the equipment description information repository 311 and the rack equipment management plan information repository 312. Coordination component 313 can provide a correlation between policies associated with a particular client and rack equipment implementing the client's applications. For example, if a client agrees to a particular policy associated with a particular rack equipment operation setting and the client engages in a policy alteration protocol to change the operation setting, coordination component 313 can provide an indication if the particular piece of rack equipment running the client's application is capable of supporting the new operation setting by correlating information included in the equipment description information repository 311 and the rack equipment management plan information repository 312.

Repository management component 320 controls the organization and population of information in the equipment description information repository 311 and the rack equipment management plan information repository 312. The information can be populated in a number of ways. In one exemplary implementation, available equipment information can be automatically retrieved from equipment (e.g., servers, disk arrays, fans, etc.) and forwarded to equipment description information repository 311. For example, if a rack mounted server has accessible information (e.g., from a memory or register included in the server) that includes indications of the server's features and characteristics (e.g., varying operating levels), repository management component 320 can retrieve the equipment information via communication link 330. Rack equipment management plan information can also be automatically extracted from a client agreement database or file. For example, repository management component 320 can interface with a database of client information (e.g., a database associated with an online service purchase application) and extract information associated with a rack equipment management plan information.

The equipment information can also be entered via interface module 325 of repository management component 320. For example, an operator or user can manually enter the information. Alternatively, the information can be downloaded automatically from an external and/or remote system. The present invention's diverse and extensive equipment information retrieval and storage capabilities permit a flexible and “rich” set of rack equipment management plan policies and guidelines to be implemented.

Repository management component 320 can include a variety of different configurations. As illustrated in FIG. 3, repository management component 320 can include rack equipment description retrieval module 321, rack equipment management plan module 322, rack equipment correlation module 323 and instruction saving module 324. A rack equipment description retrieval module 321 controls automatic retrieval of rack equipment description information. Rack equipment management plan module 322 directs establishment of a rack equipment management plan. Rack equipment correlation module 323 provides correlation instructions to a correlation component. Instruction saving module 324 directs rack equipment description information and the rack equipment management plan information saving operations (e.g., a memory write operation).

Rack equipment management plan module 322 can facilitate determination of rack equipment management objectives. Rack equipment management plan module 322 can analyze information from a variety of other sources including information received manually from operators of rack equipment management information coordination system 300 (e.g., via an interface). In addition, rack equipment management plan module 322 can analyze information received automatically from a customer service database (e.g., a database comprising terms and conditions of customer service agreements between clients and a host). The analyses by rack equipment management plan module 322 produces rack equipment management objectives (e.g., by extraction and/or extrapolation from the analyzed information).

It is appreciated that a rack equipment management information coordination method and system can be utilized in conjunction with a variety of rack equipment management objectives. For example, a rack equipment management information coordination method and system can be utilized to manage information associated with rack equipment performance management objectives. Management objectives can indicate that if a high priority application is being implemented high performance settings are established. Conversely, a management objective can also indicate that if a low priority application is being implemented that a low performance setting is established. Management objectives can indicate that if a temperature measurement indicates the temperature in and/or around the rack equipment is increasing that rack equipment heat dissipation is increased and/or or additional cooling is provided. If the temperature in and/or around the rack equipment is decreasing, a management objective can indicate that the power consumption and/or performance level of the rack equipment is increased.

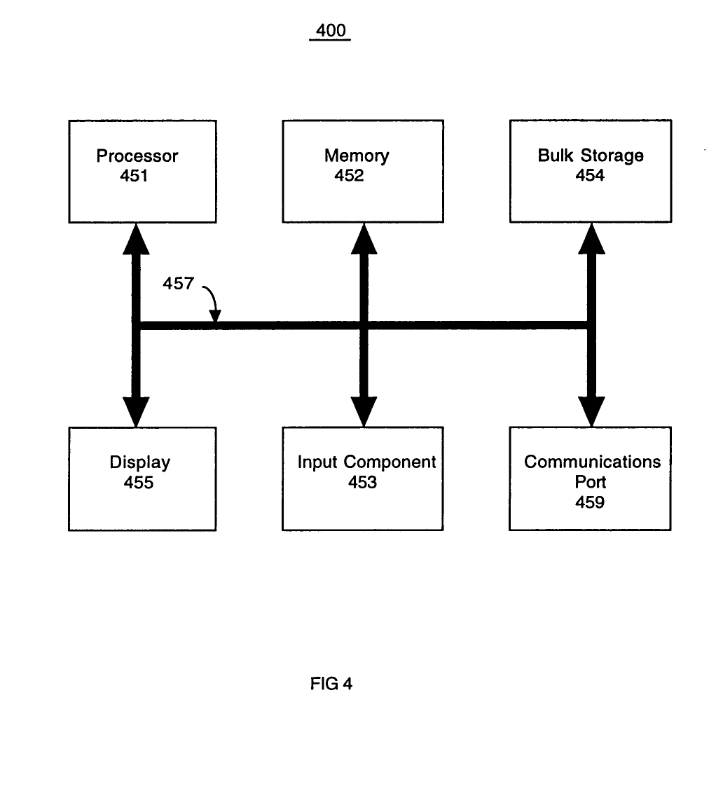

FIG. 4 is a block diagram of computer system 400, one embodiment of a computer system on which the present invention can be implemented. For example, computer system 400 can be utilized to implement rack equipment management information coordination method 100 and/or repository management component 320. Computer system 400 includes communication bus 457, processor 451, memory 452, input component 453, bulk storage component 454 (e.g., a disk drive), network communication port 457 and display module 455. Communication bus 457 is coupled to central processor 451, memory 452, input component 453, bulk storage component 454, network communication port 459 and display module 455.

The components of computer system 400 cooperatively function to provide a variety of functions, including performing rack equipment management information coordination in accordance with the present invention. Communication bus 457 communicates equipment rack management related information within computer system 400. Processor 451 processes information and instructions, including instructions and information for managing rack equipment information coordination (e.g., processor 451 processes instruction for rack equipment description retrieval module 321, rack equipment management plan module 322, rack equipment correlation module 323 and instruction saving module 324, etc.). Memory 452 stores information and instructions, including instructions for implementing rack equipment information coordination. Bulk storage component 454 also provides storage of information (e.g., rack equipment description information, policy information, etc.). One embodiment of a present interface can be implemented by input component 453, display module 455 and network communications port 459. Input component 453 facilitates communication of information (e.g., operator policy initiated changes, operator entered rack equipment description information, operator intervention in management actions, etc.) to computer system 400. Display module 455 displays information to a user (e.g., a graphical user interface conveying rack equipment operation settings and performance levels, rack equipment description information, policy information, correlation between the information, etc.). Network communication port 457 provides a communication port for communicatively coupling with a network (e.g., for communicating with a client, a utility, a remote operator and/or control center, etc.).

Thus, a present invention rack equipment management information coordination system and method facilitates convenient and efficient automatic detection, encoding, storage and manipulation of rack equipment management information. Numerous possible characteristics of the different pieces of rack equipment and rack support equipment potentially deployed in a centralized resource center can be automatically tracked and organized, including a variety of possible performance settings that each piece of rack equipment and support equipment may be capable of, information on various potential capacity limits and usage constraints (e.g., predetermined fixed aggregate power consumption and thermal dissipation limits or budget), and information on numerous different client agreement terms. A variety of different types of information is automatically collected and correlated, including absolute maximum ratings defined by regulatory requirements of power supply vendors, amount of current flowing through a branch circuit, manual partial configuration of rack equipment, impacts of partial configuration on performance, local environmental conditions, cost of maintaining power and thermal envelopes, and economic value of computing services running on the rack equipment. The information storage configurations are flexibly adaptive for a variety of implementations and are conveniently accessible by various interfaces in a unified and correlated manner.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various modifications as are suited to the particular use contemplated. It is intended that the scope of the invention be defined by the Claims appended hereto and their equivalents.

1. A rack equipment management information coordination method comprising:
formulating a rack equipment management plan;
directing automatic equipment description information detection; and
storing the rack equipment description information and rack equipment management plan.

2. A rack equipment information coordination method of claim 1 further comprising retrieving possible performance level settings from rack equipment.

3. A rack equipment information coordination method of claim 2 wherein said possible performance level settings from rack equipment include wattage settings.

4. A rack equipment information coordination method of claim 1 wherein said rack equipment management plan includes management objective guidelines.

5. A rack equipment information coordination method of claim 1 wherein said rack equipment management plan includes power and thermal budget guidelines.

6. A rack equipment information coordination method of claim 1 wherein formulating said rack equipment management plan further comprises interfacing with a service agreement application.

7. A rack equipment information coordination method of claim 1 further comprising integrating said rack equipment description information with said rack equipment management plan.

8. A rack equipment information coordination system comprising:
an equipment description information repository for tracking equipment description information;
a management plan information repository for tracking rack equipment management plan information; and
a coordination component for coordinating said equipment description information and said rack equipment management plan information.

9. A rack equipment information coordination system of claim 8 wherein said equipment description information repository stores information associated with features and characteristics of rack equipment and support equipment.

10. A rack equipment information coordination system of claim 8 wherein said equipment description information repository stores information indicating possible operation settings of rack equipment.

11. A rack equipment information coordination system of claim 8 wherein said equipment description information repository stores information indicating rack equipment is capable of operating at varying power levels and corresponding heat generated at each level.

12. A rack equipment information coordination system of claim 8 wherein said equipment description information repository stores performance level information.

13. A rack equipment information coordination system of claim 8 wherein said management plan information repository tracks management policy and guideline information associated with a rack equipment management plan.

14. A rack equipment information coordination system of claim 8 wherein policy information can provide a correlation between a trigger event and a rack equipment management objective.

15. A rack equipment information coordination system of claim 8 wherein said coordination component provides a correlation between policies associated with a particular client and rack equipment implementing the client's applications.

16. A rack equipment information coordination system of claim 8 further comprising:
a repository management component for managing information flow to and from said equipment description information repository and said management plan information repository; and
a communication link for communicating information to and from said repository management component.

17. A computer system comprising:
a means for communicating rack equipment related information;
a means for storing said rack related information and instructions, including instructions for implementing rack equipment information coordination; and
a means for processing information and instructions, including said instructions and information for managing rack equipment information coordination.

18. A computer system of claim 17 further comprising:
a rack equipment description retrieval module for controlling automatic retrieval of rack equipment description information;
a rack equipment management plan module for directing establishment of a rack equipment management plan;
a rack equipment correlation module for providing correlation instructions to a correlation component; and
an instruction saving module for directing rack equipment description information and the rack equipment management plan information saving operations.

19. A computer system of claim 18 wherein said rack equipment management plan module facilitates determination of rack equipment management objectives.

20. A computer system of claim 18 wherein said rack equipment management information coordination is utilized to support a variety of rack equipment management objectives.
